(19) United States
(12) Patent Application Publication
(10) Pub. No.: US 2023/0101424 A1
(43) Pub. Date: Mar. 30, 2023

(54) METHOD AND APPARATUS FOR ACTIVE LEARNING BASED CALL CATEGORIZATION

(71) Applicant: Uniphore Technologies Inc., Palo Alto, CA (US)

(72) Inventors: Basuraj AGRAWAL, Palo Alto, CA (US); Victor BARRES, Palo Alto, CA (US); Patrick EHLEN, Palo Alto, CA (US); Samith RAMACHANDRAN, Palo Alto, CA (US); Mansi RANA, Palo Alto, CA (US)

(21) Appl. No.: 17/491,527

(22) Filed: Sep. 30, 2021

(51) Int. Cl. G06N 20/00; G06Q 10/06; G06F 16/22; H04M 3/523

(52) U.S. Cl. CPC G06N 20/00; G06Q 10/06393; G06F 16/2291; H04M 3/523

(57) ABSTRACT

A method and apparatus for active learning based call categorization include a method for categorizing a call automatically. The method includes generating a plurality of first scores corresponding to a plurality of first parameter candidates and a plurality of second scores corresponding to a plurality of second parameter candidates, based on at least one of a transcript of a call between a customer and an agent, or a CRM data associated with the call. The method further includes determining at least one first parameter from the plurality of first parameter candidates based on the plurality of first scores, and determining at least one second parameter from the plurality of second parameter candidates based on the plurality of second scores.

### FIELD

The present invention relates generally to speech audio processing, and particularly to use of active learning for call categorization.

### BACKGROUND

Several businesses need to provide support to its customers, which is provided by a customer care call center. Customers place a call to the call center, where customer service agents address and resolve customer issues, to satisfy the customer's queries, requests, issues and the like. The agent uses a computerized call management system used for managing and processing calls between the agent and the customer. The agent attempts to understand the customer's issues, provide appropriate resolution, and achieve customer satisfaction. Frequently, audio of the call is stored by the system for the record, quality assurance, or further processing, such as call analytics, among others.

A continuous stream of calls, complexity of the content of calls, among other factors significantly increase the cognitive load on the agent, and in most cases, increase the after call workload (ACW) for the agent. Conventional techniques to assist the agent may suffer from several disadvantages, such as low accuracy, high training times, among others.

Therefore, there exists a need for improving the state of the art in active learning for call categorization.

### SUMMARY

The present invention provides a method and an apparatus for active learning based call categorization, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an apparatus for active learning based call categorization, in accordance with an embodiment.

FIG. 2A illustrates a schematic of a method for initial training of a first machine learning (ML) model, in accordance with an embodiment.

FIG. 2B illustrates a schematic of a method for initial training of a second machine learning (ML) model, in accordance with an embodiment.

FIG. 3 illustrates a flow diagram of a method for active learning based call categorization, in accordance with an embodiment.

FIG. 4 illustrates a method for categorizing a call, in accordance with an embodiment.

FIG. 5 illustrates a method for active learning using a human input, in accordance with an embodiment.

FIG. 6 illustrates a user interface for receiving a human input, in accordance with an embodiment.

FIG. 7 illustrates a user interface for receiving a human input, in accordance with an embodiment.

### DETAILED DESCRIPTION

Embodiments of the present invention relate to a method and an apparatus for active learning based call categorization in a call center environment, including, for example, identifying intent lines, call category, call journey, among several other parameters pertinent to a call between a customer and an agent of the call center. An active learning machine learning (ML) model is first pretrained to determine one or more parameters, such as, for example, one or more intent lines, a call category, among others. In some embodiments, the active learning ML model includes different ML models for determining different parameters, for example a first ML model for determining intent lines, and a second ML model for determining the call category, and additional ML models for other parameters. The active learning ML model is pretrained to a desired level of accuracy and/or with a desired volume of training material, and then introduced into an active learning training phase.

In the active learning training phase, the active learning ML model generates parameters with associated scores, based on call transcripts and/or CRM data. Continuing the example of intent lines and call category, the active learning ML model identifies intent lines with respective probability scores (indicating a probability that a given line is an intent line) for each identified intent line, and a call category with a probability score (indicating a probability that the identified call category is the actual call category). The generated parameters having a low level of confidence, for example, for which associated scores, such as the probability scores, are lower compared to a predefined confidence threshold are sent for human annotation. The human annotator either affirms the parameters identified by the active learning ML model, or corrects the parameters.

In the running example, the active learning ML model determines one or more lines from the transcript as intent lines, each with a probability score lower than a predefined probability threshold for intent lines, and therefore, the intent lines are sent for human annotation. A human (e.g., a person trained to determine (identify, annotate) the parameters) may either affirm the intent lines identified by the active learning ML model or correct the intent lines by deselecting the lines identified by the active learning ML model and selecting other lines. Similarly, if a call category is determined with a probability score that is less than a predefined probability threshold for call category, then the determined call category is sent to the human annotator, who may either affirm or correct the call category.

The human input (whether an affirmation or a correction) on the parameters determined by the active learning ML model in the training phase is used to train the active learning ML model further to improve the accuracy of the active learning ML model. Upon achieving desired accuracy levels with respect to parameters (e.g., predefined accuracy threshold for each parameter), the active learning ML model is introduced into an active learning deployed phase. In the training phase, the human providing the human input does not need to be a data scientist or a person highly trained with machine learning techniques. Instead, the human can be any person capable of determining the parameters, and in the running example, a person capable of identifying the intent line or lines and a call category, thereby allowing training of the active learning ML model by relatively lower skilled person.

The deployed phase works similar to the training phase, except that when deployed, the human input is provided by the agent. That is, for each call, the human (the agent) either affirms the determined parameters (no changes detected) or corrects the determined parameters (changes by the agent detected). Further, in the deployed phase, the accuracy of the active learning ML model is not evaluated, and the active learning method is iterated over more calls, yielding continuous improvement of accuracy.

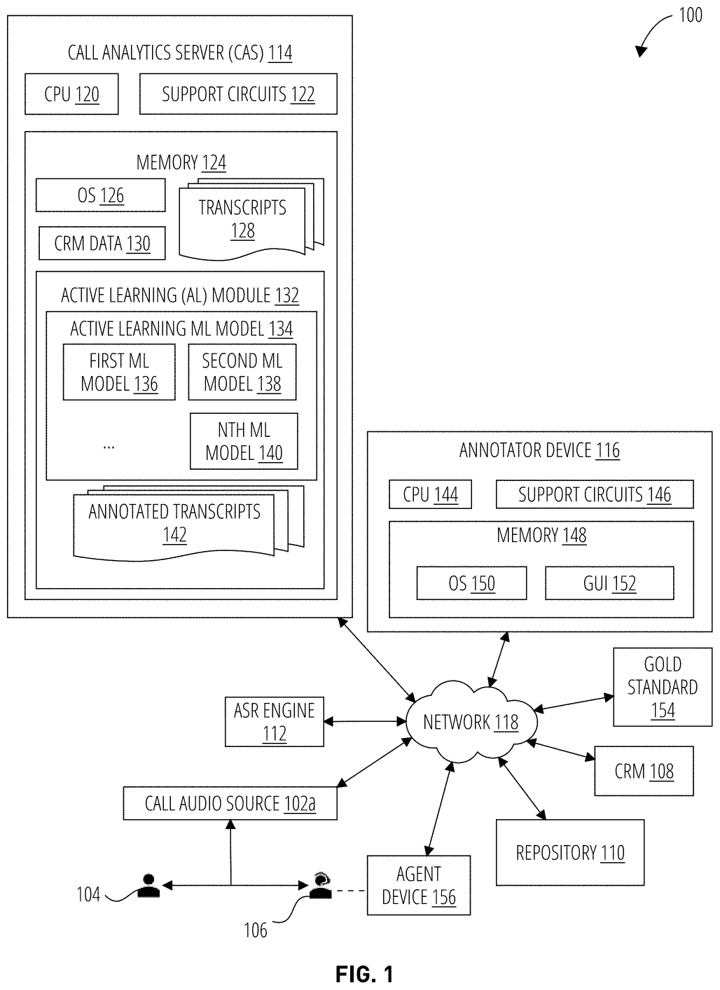

FIG. 1 is an apparatus 100 for active learning based call categorization, in accordance with an embodiment. The apparatus 100 includes a call audio source 102a, for example, a call center to which a customer 104 places a call, and converses with an agent 106. The apparatus 100 also includes a repository 110, a customer relationship management (CRM) system 108, an ASR engine 112, a CAS 114, an annotator device 116, a gold standard 154, and an agent device 156, each connected via a network 118. In some embodiments, one or more components may be connected directly to other components via a direct communication channel (wired, wireless, separate network other than the network 118), and may or may not be connected via the network 118. In some embodiments, the annotator device 116 and/or the agent device 156 are remote to the CAS 114, and in some embodiments, the annotator device 116 and/or the agent device 156 are local to the CAS 114.

The call audio source 102a provides audio of a call to the CAS 114. In some embodiments, the call audio source 102a is a call center providing live or recorded audio of an ongoing call between a call center agent 106 and a customer 104 of a business which the agent 106 serves.

The CRM 108 is a system of the business, regarding which the customer 104 makes the call to the business' call center agent 106. The CRM 108 may include information about one or more of the customers, the agents, the business, among other information relating to the call. The information obtained from the CRM 108 is referred to as call metadata. In some embodiments, the metadata includes customer specific data like details of the caller, and previous call history with reasons for call.

In some embodiments, the repository 110 includes recorded audio of calls between a customer and an agent, for example, the customer 104 and the agent 106 received from the call audio source 102a. In some embodiments, the repository 110 also includes a transcripts corresponding to the calls, and associated CRM data of the calls. In some embodiments, the repository 110 includes training audios, such as previously recorded audios between a customer and an agent, or custom-made audios for training. In some embodiments, the repository 110 includes training transcripts of calls usable for training machine learning (ML) models, and the transcripts may further include certain parameters annotated thereon. In some embodiments, the repository 110 includes training CRM data for training ML models. The training audios, transcripts and CRM data mimic real life scenarios, and may include parameters that are used to train the ML models to predict such parameters when provided a real life scenario. In some embodiments, the repository 110 is located in the premises of the business associated with the call center.

The ASR engine 112 is any of the several commercially available or otherwise well-known ASR Engines, as generally known in the art, providing ASR as a service from a cloud-based server, a proprietary ASR Engine, or an ASR Engine which can be developed using known techniques. ASR Engines are capable of transcribing speech data (spoken words) to corresponding text data (text words or tokens) using automatic speech recognition (ASR) techniques, as generally known in the art, and include a timestamp for some or each token(s). In some embodiments, the ASR engine 112 is implemented on the CAS 114 or is co-located with the CAS 114.

The CAS 114 includes a CPU 120, support circuits 122, and a memory 124. The CPU 120 may be any commercially available processor, microprocessor, microcontroller, and the like. The support circuits 122 comprise well-known circuits that provide functionality to the CPU 120, such as, a user interface, clock circuits, network communications, cache, power supplies, I/O circuits, and the like. The memory 124 is any form of digital storage used for storing data and executable software. Such memory includes, but is not limited to, random access memory, read only memory, disk storage, optical storage, and the like. The memory 124 includes computer readable instructions corresponding to an operating system (OS) 126, transcripts 128, a CRM data 130, and an active learning (AL) module 132.

The transcripts 128 includes transcripts of calls, such as, for example, those received from the call audio source 102a or the repository 110, and transcribed using the ASR engine 112. The CRM data 130 is received from the CRM 108.

The active learning (AL) module 132 includes an active learning ML model 134, and annotated transcripts 142 (for example, annotated by the active learning ML model 134). The active learning ML model 134 includes a first ML model 136 and a second ML model 138. The first ML model 136 is configured to determine first score(s) corresponding to first parameter candidate(s), and/or the first parameter(s), based on one or more of the transcript, or the CRM data. The second ML model 138 is configured to determined the second score(s) corresponding to second parameter candidate(s) and/or the second parameter(s), based one or more of the transcript, the CRM data, or the first parameter(s). In some embodiments, the active learning ML model 134 includes more than two ML models, for example, 3rd, 4th . . . Nth ML model 140 for identifying more parameters, based on one or more of the transcript, the CRM data, or output of other ML models. In some embodiments, the ML models are transfer learning based. In some embodiments, the ML models include classifier models, regression ML models, combinations thereof, as known in the art. In some embodiments, classifier ML models are used to predict the reason for the call, for example, the intent lines and the intent labels.

The annotated transcripts 142 are transcripts 128 annotated by the active learning ML model 134 with one or more parameters, such as the first parameter, a second parameter, and corresponding scores associated with the one more parameters. In the running example discussed earlier, the first parameter is one or more lines representing an intent of the call or a resolution of the intent, also referred to as intent line(s). Each of the one or more intent lines are associated with a corresponding score, for example, a probability score that the given line is an intent line. In the running example, the second parameter is a category to which the call should be assigned, also referred as a call category, call type or an intent label.

The annotator device 116 includes a CPU 144, support circuits 146, and a memory 148. The CPU 144 may be any commercially available processor, microprocessor, microcontroller, and the like. The support circuits 146 comprise well-known circuits that provide functionality to the CPU 144, such as, a user interface, clock circuits, network communications, cache, power supplies, I/O circuits, and the like. The memory 148 is any form of digital storage used for storing data and executable software. Such memory includes, but is not limited to, random access memory, read only memory, disk storage, optical storage, and the like. The memory 148 includes computer readable instructions corresponding to an operating system (OS) 150, and a graphical user interface (GUI) 152. In some embodiments, the GUI 152 is capable of displaying information, for example, a transcribed text, annotations, parameters, and the like to a human, and receiving one or more inputs from the human thereon.

The gold standard 154 includes transcripts with defined parameters that are considered accurate. For example, the gold standard 154 includes transcripts of various calls, in which the transcripts include annotations representing the intent lines, and a call category. In some embodiments, the gold standard 154 is provided and/or hosted by the business. As such, the gold standard is treated as the ground truth which reflects the expected behavior or the acceptable behavior when a request is placed. The gold standard is also expected to be the truth when evaluating a particular data point, and various model(s) affirm to the truth they learns from the gold standard.

The agent device 156 is a computer similar to the annotator device 116, and includes a GUI similar to the GUI 152. The agent device 156 is accessible by the agent 106. The “annotator device” and the “agent device” are both used for annotation in the same manner, and may just be used by different persons. It would be understood that the terms may be used interchangeably unless apparent from the context.

The network 118 is a communication network, such as any of the several communication networks known in the art, and for example a packet data switching network such as the Internet, a proprietary network, a wireless GSM/CDMA network, among others. The network 118 is capable of communicating data to and from the call audio source 102a (if connected), the repository 110, the CRM 108, the ASR engine 112, the CAS 114, the annotator device 116 and the gold standard 154.

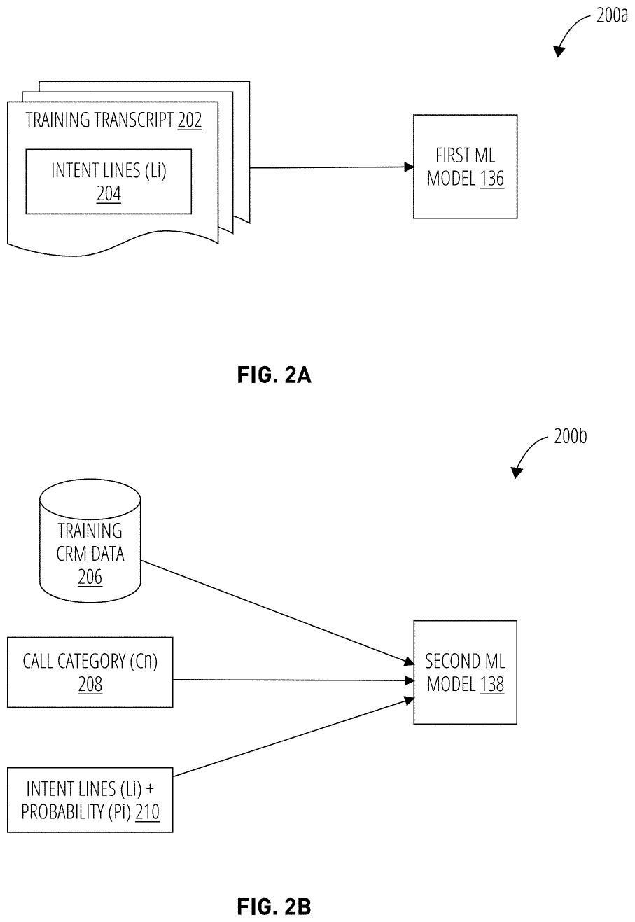

FIG. 2A illustrates a schematic of a method 200a for pretraining a machine learning (ML) model, for example, the first ML model 136, in accordance with an embodiment. In the method 200a, a training transcript 202 is provided to the first ML model 136. The training transcript 202 includes intent lines (Li), where 1′ denotes the ith line. In some embodiments, the intent lines are annotated in the training transcript 202, and the annotation is recognizable by the first ML model 136.

In some embodiments, upon being pretrained, the first ML model 136 is configured to generate an output determining probability scores for some or all lines of a transcript, based on an input of a transcript of a call. The lines for which the probability score is generated are considered as intent line candidates. In some embodiments, the first ML model 136 is further configured to identify or determine the intent line candidates having corresponding probability scores higher than a first pretraining threshold, as the intent lines. While some embodiments have been described with respect to intent line candidates having the top 3 probability scores, the embodiments can be performed with a different number of intent line candidates.

FIG. 2B illustrates a schematic of a method 200b for pretraining a machine learning (ML) model, for example, the second ML model 138, in accordance with an embodiment. In the method 200b, intent lines (Li), associated probability scores (Pi), call category (Cn) are provided to the second ML model 138. In some embodiments, the training CRM data 206 is also provided as a training input to the second ML model 138.

In some embodiments, upon being pretrained, the second ML model 138 is configured to generate an output determining probability scores for some or all call categories, based on an input of the intent lines and probability scores for the intent lines provided by the first ML model 136, and optionally, additionally based on the CRM data associated with calls. The call categories for which the probability score is generated are considered as call category candidates. In some embodiments, the second ML model 138 is further configured to identify or determine the call category candidate having the highest probability score, as the call category (call type or intent label).

The pretraining phase is conducted till desired levels of accuracy are achieved for the first ML model and/or the second ML model, or each of the first ML model and the second ML model is trained using a fixed number of training transcripts and associated intent lines and call categories.

In some embodiments, the methods 200a and 200b are performed by active learning (AL) module 132, using known techniques. In some embodiments, the first ML model and the second ML model are received as ready to use models, pretrained using techniques similar to those described above.

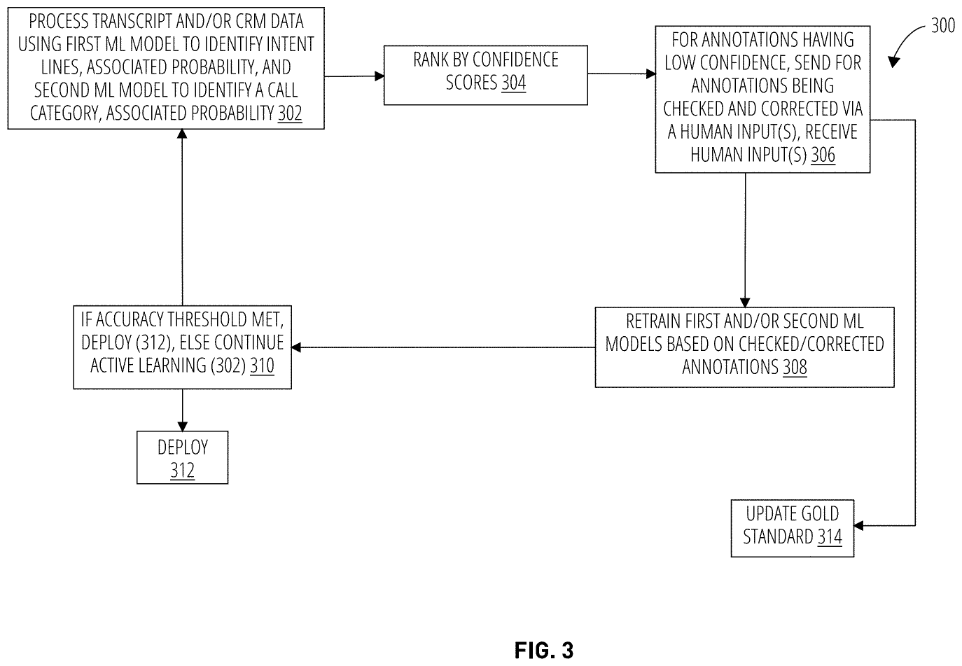

FIG. 3 illustrates a flow diagram of a method 300 for active learning based call categorization, in accordance with an embodiment. According to some embodiments, the method 300 is performed by the CAS 114 of FIG. 1. Blocks 302-310 are repeated in a learning phase of the active learning ML model 134 till a desired accuracy is achieved, after which, the blocks 302-310 are iterated in a deployed phase.

At block 302, the method 300 processes a transcript and CRM data of a call using the active learning ML model 134 to identify intent lines, associated probability score of each intent line, call category and associated probability score of the call category. In the running example, at block 302, the method 300 uses the first ML model 136 (pretrained according to the method 200a) of the active learning ML model 134, based on an input of a transcript of a call, to generate (annotate, or identify) one or more intent lines in the transcript, and an associated probability score for each of the intent lines. In some embodiments, probability score for all lines of the transcript are generated, and each line is an intent line candidate. The probability score associated with each of the intent line candidate is a probability that the line candidate includes the intent of the call therein. In some embodiments, the first ML model 136 selects the line candidates with top 3 associated probability scores to determine top 3 intent lines and associated probability scores. In some embodiments, the first ML model is configured to generate 3 intent lines and a probability score for each of the 3 intent lines, while in other embodiments, a lower or a greater number of intent lines and associated scores may be generated.

The 3 intent lines and the associated probability scores are input to the second ML model 138 (pretrained according to the method 200b) of the active learning ML model 134. In some embodiments, the CRM data of the call are also input to the second ML model 138 in addition to the 3 intent lines and the associated probability scores. The second ML model 138 generates (identifies or annotates) probability scores for each call category (call type or intent label), for example, from a list of call categories, and each of the call category is treated a call category candidate. The probability score of each call category candidate is the probability that the call category candidate is the correct call category. The second ML model 138 identifies the call category candidate with the highest probability score as the call category.

In this manner, the active learning ML model 134 generates an output of 3 intent lines, corresponding 3 probability scores that a given intent line includes the intent/resolution of the intent, a call category, and a probability score that the call category is the correct category, based on an input of the CRM data of the call.

The method 300 proceeds to block 304, at which the method 300 ranks the output generated at block 302 according to confidence scores. Confidence scores are generated based on the number of transcripts belonging to a particular category that are rightly predicted, and the number of categories that are wrongly predicted into a given intent category. In some embodiments, the confidence score is used to predict the call categories that need to be sent for human input (annotation), and which categories need not be sent for human input (annotation). which intent category to focus on, and which category do we need to hold off from further annotation. If the confidence scores of the 3 intent lines are below a first confidence threshold score, and/or the confidence score of the call category is below a second confidence threshold, the output is marked for human input via blocks 306 and 308 and the method 300 proceeds to block 306. If the output is not marked for human input, that is, the confidence scores of the intent lines and/or the call category are equal to or higher than the respective confidence threshold values, then the method 300 proceeds to block 310.

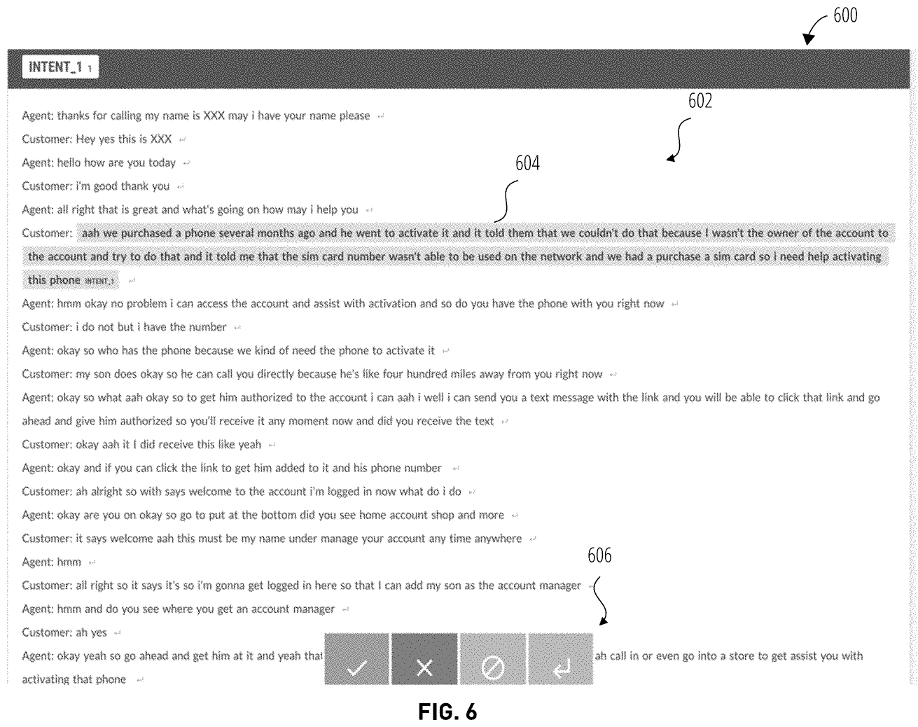

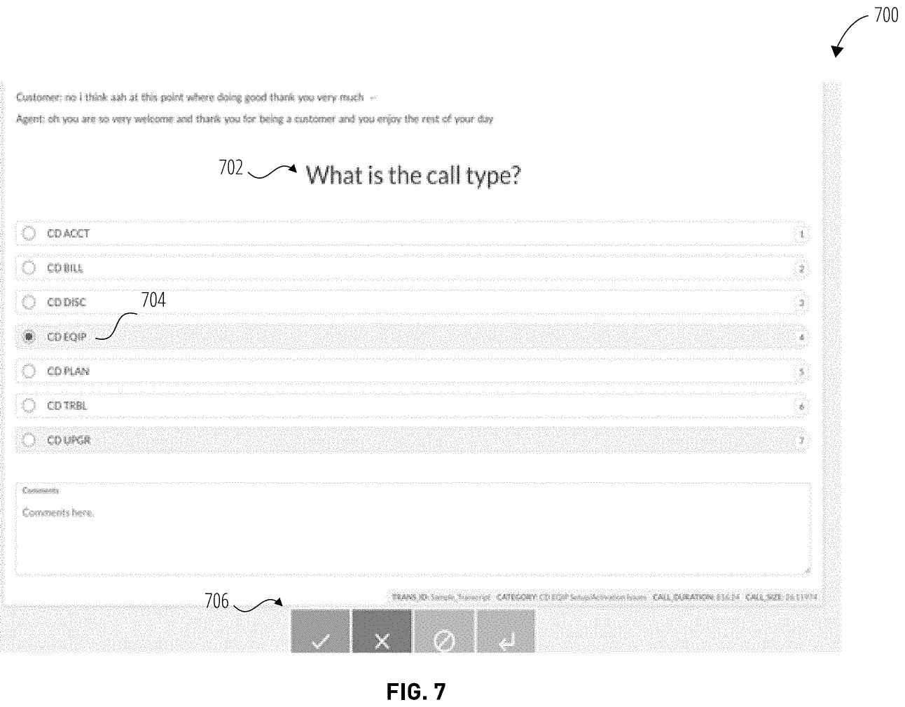

For the output (annotations of the 3 intent lines and/or the call category) having a low confidence score, the method 300 proceeds to block 306, at which the output is sent from the CAS 114 to be displayed to a human, for example, at the annotator device 116 accessible to the human for the purpose of viewing the output and providing input(s) thereon. In the learning phase, the human can be a data scientist or any other person trained to identify the intent line(s) and/or the call category correctly. In some embodiments, the training phase of the active learning ML model is performed by a service provider different from the business, and the human using the annotator device 116 is a personnel of the service provider. The human input either affirms that the output (3 intent lines and/or the call category) was correct, or the human input corrects the output, that is, changes one or more of the intent lines and/or the call category. The human input, for example annotations or selections affirming or correcting the output, is received at the annotator device 116, and sent from the annotator device 116 to the CAS 114. The display of the output at the annotator device 116 and receiving the human input thereon is discussed in further detail with respect to FIG. 6 and FIG. 7.

The human input, whether affirming or correcting the output, qualifies the output of the active learning ML model as being correct, and performed by the method 300, which proceeds from block 306 to block 308. At block 308, the method 300 retrains the active learning ML model 134 based on the human input, and in the running example, retrains the first ML model 136 and/or the second ML model 138 based on the human input using known techniques. In some embodiments, retraining of the ML models is triggered when the confidence on a particular category increases, and an auto retraining process for the model is launched.

The method 300 proceeds from block 308 to block 310, or arrives at block 310 directly from block 304 (not shown) as discussed above. At block 310, the method 300 determines an accuracy of the active learning ML model 134. If the accuracy is lower than an accuracy threshold, the method 300 iterates blocks 302-310 with more call transcripts and CRM data in the learning phase. Accuracy is determined using multiple attributes, including precision, recall, and accuracy of intent lines and call category, and using statistical accuracy analyses, for example, determining an F1-score. Accuracy thresholds are configured to balance or trade-off based on the use-case, a business requirement, and the property of independent and identical distribution of data. In some embodiments, accuracy thresholds are decided based on a desired level of selectiveness when filtering results.

If however, the accuracy is equal to more than the accuracy threshold, then the active learning ML model 134 is considered ready for deployment, and the method 300 proceeds to block 312, at which the active learning ML model 134 is deployed, and the method 300 enters the deployed phase.

In the deployed phase, the active learning active learning ML model 134 is deployed by the business, and blocks 302-308 of the method 300 are performed iteratively, that is, the method proceeds from block 308 to block 302, at which the method 300 processes a new transcript and associated CRM data. Further, if at block 304, the first or second confidence scores are higher than the corresponding first confidence threshold and/or the second confidence threshold, the method 300 proceeds t block 302. Further, in the deployed phase, the human input of block 306 is provided by a personnel of the business, for example, the agent 106, using the agent device 156, in a similar manner as provided by a human on the annotator device 116.

In some embodiments, in addition to proceeding to retrain the first ML model and the second ML model at block 308 after receiving the human input at block 306, the method 300 is also configured to update a gold standard at block 314 based on the human input provided at block 306. The method 300 can perform block 314 in both the training phase and the deployed phase.

The initially pretrained ML models are trained further in an active learning training phase, during which blocks 302, 304, 306 and 308 of the method 300 are iterated till a desired accuracy threshold has been met (block 310). Once the desired accuracy threshold has been met, the ML models are deployed (block 312) in an active learning deployed phase, in which the blocks 302, 304 and 306 are iterated continually. In this manner, in both the training phase and the deployed phase, the first ML model and the second ML model, or the active learning ML model continues to learn and improve.

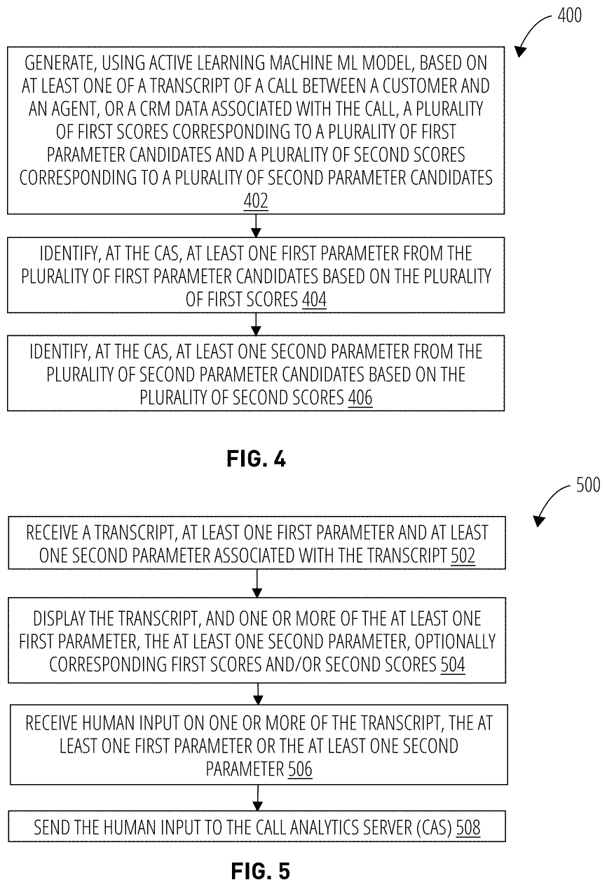

FIG. 4 illustrates a method 400 for categorizing a call, in accordance with an embodiment. The method 400 is performed by, for example, active learning (AL) module 132 of the apparatus 100 of FIG. 1.

At block 402, the method 400 generates multiple first scores corresponding to multiple first parameter candidates and multiple second scores corresponding to a multiple second parameter candidates. The method 400 generates the first and second parameter candidates and associated scores using an active learning ML model, based on an input of a transcript of a call between a customer and an agent, and/or a CRM data associated with the call. In some embodiments, the active learning ML model is the active learning ML model 134 having the first ML model 136, which generates the first parameter candidates and associated first scores, and the second ML model 138, which generates the second parameter candidates and associated second scores. In some embodiments, the second ML model 138 also receives one or more output(s) of the first ML model 136 in addition to the transcript and the CRM data of the call. For example, as discussed above with respect to FIG. 3, the second ML model received the 3 intent lines (first parameter) and the probability scores (first scores) for each of the 3 lines from the first ML model, in order to generate probability scores (second scores) for call category (second parameter) candidates.

At block 404, the method 400 identifies one or more first parameters from the first parameter candidates based on the first scores of each of the first parameter candidates. At block 406, the method 400 identifies one or more second parameters from the second parameter candidates based on the second scores of each of the second parameter candidates.

In some embodiments, the method 400 further includes determining the first parameter(s) by identifying first parameter candidates from the multiple first parameter candidates having the highest first score, or a highest score range (e.g., top 3, or score of 80 percentile or higher) among the first scores. In some embodiments, the method 400 further includes determining the second parameter(s) by identifying second parameter candidates from the multiple second parameter candidates having the highest second score, or a highest score range among the second scores. For example, as discussed with respect to FIG. 3, the intent line candidates having the top 3 probability scores are identified as the intent lines, and the call category candidate having the highest probability score is identified as the call category.

In some embodiments, the method 400 further includes sending, from the CAS 114 to the annotator device 116 or the agent device 156, the first parameter(s) for display on the annotator device/agent agent device, and thereafter, receiving a first human input (e.g., annotation) on the first parameter(s) at the CAS 114 from the annotator device/agent agent device. The first human input either affirms or corrects the first parameter(s). The active learning (AL) module 132 updates the active learning ML model 134 and/or the first ML model based on the first human input.

Similarly, in some embodiments, the method 400 further includes sending, from the CAS 114 to the annotator device 116 or the agent device 156, the second parameter(s) for display on the annotator device/agent agent device. Thereafter, the method 400 receives a second human input (e.g., annotation) on the second parameter(s) at the CAS 114 from the annotator device/agent device. The second human input either affirms or corrects the second parameter(s). The active learning (AL) module 132 updates the active learning ML model 134 and/or the second ML model based on the second human input.

In some embodiments, the method 400 further includes deploying the active learning ML model after measuring accuracy of the first parameter(s) or the second parameter(s), and deploying the active learning ML model if the accuracy of the first parameter(s) satisfies a first accuracy threshold, and/or the accuracy of the second parameter(s) satisfies a second accuracy threshold.

In some embodiments, the method 400 further includes sending the first parameter(s) to the annotator device/agent device if the first score of the first parameter(s) satisfies a first probability threshold. Similarly, in some embodiments, the method 400 further includes sending the second parameter(s) to the annotator device/agent device if the second score of the second parameter(s) satisfies a second probability threshold.

In some embodiments, the active learning ML model includes the first ML model and the second ML model, and the method 400 further includes generating the first score(s) using the first ML model, and generating the second score(s) using the second ML model based on the first parameter.

In some embodiments, each of the first parameter candidates is a line in the transcript, and each of the first scores is a probability that the corresponding first parameter candidate is a line representing at least one of the intent of the call, or a resolution to the intent of the call. Similarly, each of the second parameter candidates is a call category defining the type of the call, and each of the second scores is a probability that the corresponding second parameter candidate is a call category for the call.

FIG. 5 illustrates a method 500 for active learning using a human input, in accordance with an embodiment. The method 500 is performed by the annotator device 116 or the agent device 156, for example, as discussed above, and described in further detail with respect to FIG. 6 and FIG. 7.

At block 502, the method 500 receives a transcript, one or more first parameters and one or more second parameters associated with a transcript. In some embodiments, the first and/or the second parameters are annotated on the transcript, including highlighting of portions of the transcript, overlay text among others. At block 504, the method 500 displays the transcript, and one or more of the first parameters, the second parameters, corresponding first scores and/or second scores, for example, as annotations thereof, on the GUI 152 of the annotator device 116 or a GUI of the agent device 156. At block 506, the method 500 receives human input on one or more of the transcript, the first parameters, the second parameters. The human input affirms or corrects the first and/or the second parameters. At block 508, the method 500 sends the human input to the call analytics server (CAS) 114.

In some embodiments, the GUI 152 of the annotator device 116 of the GUI of the agent device 156 is a part of an application (app) available for download and installation on devices running on APPLE, ANDROID, MICROSOFT systems or other systems.

In the running example, the transcript of the call that is ingested for processing by the active learning ML model or the first ML model is: Agent: thanks for calling my name is XXX may i have your name please Customer: Hey yes this is XXX Agent: hello how are you today Customer: I'm good thank you Agent: all right that is great and what's going on how may i help you Customer: aah we purchased a phone several months ago and he went to activate it and it told them that we couldn't do that because I wasn't the owner of the account to the account and try to do that and it told me that the sim card number wasn't able to be used on the network and we had a purchase a sim card so i need help activating this phone Agent: hmm okay no problem i can access the account and assist with activation and so do you have the phone with you right now Customer: i do not but i have the number Agent: okay so who has the phone because we kind of need the phone to activate it Customer: my son does okay so he can call you directly because he's like four hundred miles away from you right now

Agent: okay so what aah okay so to get him authorized to the account i can aah i well i can send you a text message with the link and you will be able to click that link and go ahead and give him authorized so you'll receive it any moment now and did you receive the text Customer: okay aah it I did receive this like yeah Agent: okay and if you can click the link to get him added to it and his phone number Customer: ah alright so with says welcome to the account i'm logged in now what do i do Agent: okay are you on okay so go to put at the bottom did you see home account shop and more Customer: it says welcome aah this must be my name under manage your account any time anywhere Agent: hmm Customer: all right so it says it's so i'm gonna get logged in here so that I can add my son as the account manager Agent: hmm and do you see where you get an account manager Customer: ah yes Agent: okay yeah so go ahead and get him at it and yeah that'd be all that you need to do and then he'll be able to aah call in or even go into a store to get assist you with activating that phone Customer: ah well thank you Agent: all righty and yep so we just got him added as an account manager now he′ll be able to go into the store with a picture i d and get all help umm are there any other questions or anything else i can help with today Customer: no i think aah at this point where doing good thank you very much Agent: oh you are so very welcome and thank you for being a customer and you enjoy the rest of your day

Additionally, CRM data including metadata for the call, for example, call duration, call size, and the like, is also ingested for processing by the active learning ML model or the first ML model. The output of the the active learning ML model or the first ML model is sent to the annotator device 116 or the agent device 156. Further, the active learning ML model, or the first ML model and the second ML model determine or generate an output of (i) identified intent line(s) and (ii) intent category, respectively. In the running example, following is what the result looks like: First ML Model returns:

{
“Input String”: “aah we purchased a phone few months ago and aah eh we
went to activate it and it told them that we couldn't do that because uh I
wasn't the owner of the account to the account and try to do that and it
told me that the sim card number wasn't able to be used on the network
and we had a purchase a sim card so i need help activating this phone”,
“Prediction Class”: “Intent Line”,
“Prediction List”: “[‘Not Intent’, ‘Intent Line’]”,
“Prediction Probs”: “[0.000349209819, 0.999650836]”
}

Second ML Model returns:

{
″Intent Class″: ″CD EQIP′″, [Note to reader: EQIP stands for equipment
activation issues here]
″Intent Probs″: ″[0.000506768294, 9.14644188e−05, 0.997598708,
8.42750451e−05, 0.00137372199, 0.000239650166, 0.000105455685]″,
″Prediction List″: ″[′CD ACCT′, ′CD BILL′, ′CD EQIP′, ′CD RETL,
′CD UPGR, ’CD NTWK′]″
}

FIG. 6 and FIG. 7 depict display of the transcript with the first parameter (intent line) and the second parameter (call category) on a GUI, and annotation (human input) thereon, in the context of the running example.

In particular illustrates a first user interface 600 for receiving a human input, for example the GUI 152 or a GUI of the agent device 156, in accordance with an embodiment.

The first user interface 600 comprises a transcript 602, and an annotation 604 depicting the first parameter (intent line), determined by the active learning ML model or the first ML model. The first user interface 600 also includes an element to receive a human input 606. For example, the 4 buttons on the element to the receive the human input 606 include a tick mark icon to affirm the first parameter identified by the active learning ML model, and a cross icon to indicate that the first parameter is incorrect. If the first parameter is incorrect, the human may use a pointing and selecting element, such as a computer mouse cursor to select or annotate another line as the correct intent line, correcting the first parameter, and then select the enter icon to record the human input 606. In some cases, there may be no valid candidate for the first parameter, in which the human selects the invalid icon as the human input 606. The various icons and annotations are recorded as the human input 606 with respect to the first parameter (intent line) and sent to the CAS 114.

FIG. 7 illustrates a second user interface 700 for receiving a human input, for example, the GUI 152 or the GUI of the agent device 156, in accordance with an embodiment.

The second user interface 700 displays second parameter candidates 702, and the second parameter 704 determined by the active learning ML model or the second ML model. Depending on whether the second parameter 704 is correct or not, the human inputs an affirmation or a correction using the element to receive a human input 706, in a manner similar to the element 606 described with respect to FIG. 6 above. The various icons and annotations are recorded as the human input 706 with respect to the second parameter (call category/call type/intent label) and sent to the CAS 114.

The human input is considered verified input for the transcript, and is recorded as the gold standard, and further used for re-training the model.

The apparatus 100, and various components therein, are capable of performing the methods and all steps therein described herein in “real time,” which will be understood to mean as soon as possible given the physical constraints of the apparatus and components thereof, for example, processing times, communication times and the like. In some embodiments, delays may be introduced at one or more steps of the methods disclosed herein, and all such variations are included in real time, unless apparent otherwise from the context. Various techniques described herein are capable of being performed in real time, and in a passive (non real time) mode.

While an example with parameters intent lines and call categories has been used to illustrate some embodiments, such and other embodiments are not restricted to intent lines and/or call categories, and can be used with other parameters, such as, call entities, sentiment, among others. Further, all thresholds and ranking scores are fully configurable using configuration scripts, or other known techniques and can be enabled using a user interface or any method deemed sufficient to meet the configurability of the product.

The active learning techniques with human in the loop described herein enable high accuracy systems to assist agents, and enable rapid deployment by shortening the time spent on training machine learning models.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

I/We claim:

1. A method for categorizing a call, the method comprising:
generating, at a call analytics server (CAS), using an active learning machine learning (ML) model, based on at least one of a transcript of a call between a customer and an agent, or a CRM data associated with the call, a plurality of first scores corresponding to a plurality of first parameter candidates and a plurality of second scores corresponding to a plurality of second parameter candidates;
determining, at the CAS, at least one first parameter from the plurality of first parameter candidates based on the plurality of first scores; and
determining, at the CAS, at least one second parameter from the plurality of second parameter candidates based on the plurality of second scores.

2. The method of claim 1,
wherein determining the at least one first parameter comprises identifying first parameter candidates from the plurality of first parameter candidates having the highest score, or a highest score range among the plurality of first scores, and
wherein determining the at least one second parameter comprises identifying second parameter candidates from the plurality of second parameter candidates having the highest score, or a highest score range among the plurality of second scores.

3. The method of claim 1, further comprising:
sending, from the CAS to an annotator device, the at least one first parameter for display on the annotator device;
receiving, at the CAS, from the annotator device, a first human input corresponding to the at least one first parameter; and
updating, at the CAS, the active learning ML model based on the first human input.

4. The method of claim 3, wherein the annotator device is remote to the CAS.

5. The method of claim 3, further comprising:
sending, from the CAS to the annotator device, the at least one second parameter for display on the annotator device;
receiving, at the CAS, from the annotator device, a second human input corresponding to the at least one second parameter; and
updating, at the CAS, the active learning ML model based on the second human input.

6. The method of claim 5, wherein the active learning ML model is deployed after measuring accuracy of at least one of the at least one first parameter or the at least one second parameter, and
deploying the active learning ML model if the accuracy of the at least one first parameter satisfies a first accuracy threshold, the accuracy of the at least one second parameter satisfies a second accuracy threshold, or both.

7. The method of claim 5, wherein the at least one first parameter is sent to the annotator device if the first score of the at least one first parameter satisfies a first probability threshold, the at least one second parameter is sent to the annotator device if the second score of the at least one second parameter satisfies a second probability threshold, or both.

8. The method of claim 1,
wherein the plurality of first scores are generated using a first ML model.
wherein the plurality of second scores are generated using a second ML model, and are based on the at least one first parameter, the plurality of first scores, or both, and
wherein the active learning ML model comprises the first ML model and the second ML model.

9. The method of claim 1,
wherein each of the plurality of first parameter candidates is a line in the transcript, and each of the plurality of first scores is a probability score that the corresponding first parameter candidate is a line representing at least one of the intent of the call, or a resolution to the intent of the call, and
wherein each of the plurality of second parameter candidates is a call category defining the type of the call, and each of the plurality of second scores is a probability score that the corresponding second parameter candidate is a call category for the call.

10. An apparatus for categorizing a call, the apparatus comprising:
a processor; and
a memory communicably coupled to the processor, the memory comprising computer executable instructions, which when executed by the processor perform a method comprising:
generating, at a call analytics server (CAS), using an active learning machine learning (ML) model, based on at least one of a transcript of a call between a customer and an agent, or a CRM data associated with the call, a plurality of first scores corresponding to a plurality of first parameter candidates and a plurality of second scores corresponding to a plurality of second parameter candidates,
determine, at the CAS, at least one first parameter from the plurality of first parameter candidates based on the plurality of first scores, and
determine, at the CAS, at least one second parameter from the plurality of second parameter candidates based on the plurality of second scores.

11. The apparatus of claim 10,
wherein determining the at least one first parameter comprises identifying first parameter candidates from the plurality of first parameter candidates having the highest score, or a highest score range among the plurality of first scores, and
wherein determining the at least one second parameter comprises identifying second parameter candidates from the plurality of second parameter candidates having the highest score, or a highest score range among the plurality of second scores.

12. The apparatus of claim 10, wherein the method further comprises:
sending, from the CAS to an annotator device, the at least one first parameter for display on the annotator device;
receiving, at the CAS, from the annotator device, a first human input corresponding to the at least one first parameter; and
updating, at the CAS, the active learning ML model based on the first human input.

13. The apparatus of claim 12, wherein the annotator device is remote to the CAS.

14. The apparatus of claim 12, wherein the method further comprises:
sending, from the CAS to the annotator device, the at least one second parameter for display on the annotator device;
receiving, at the CAS, from the annotator device, a second human input corresponding to the at least one second parameter; and
updating, at the CAS, the active learning ML model based on the second human input.

15. The apparatus of claim 14, wherein the active learning ML model is deployed after measuring accuracy of at least one of the at least one first parameter or the at least one second parameter, and
deploying the active learning ML model if the accuracy of the at least one first parameter satisfies a first accuracy threshold, the accuracy of the at least one second parameter satisfies a second accuracy threshold, or both.

16. The apparatus of claim 14, wherein the at least one first parameter is sent to the annotator device if the first score of the at least one first parameter satisfies a first probability threshold, the at least one second parameter is sent to the annotator device if the second score of the at least one second parameter satisfies a second probability threshold, or both.

17. The apparatus of claim 10,
wherein the plurality of first scores are generated using a first ML model,
wherein the plurality of second scores are generated using a second ML model, and are based on the at least one first parameter, and
wherein the active learning ML model comprises the first ML model and the second ML model.

18. The apparatus of claim 10,
wherein each of the plurality of first parameter candidates is a line in the transcript, and each of the plurality of first scores is a probability score that the corresponding first parameter candidate is a line representing at least one of the intent of the call, or a resolution to the intent of the call, and
wherein each of the plurality of second parameter candidates is a call category defining the type of the call, and each of the plurality of second scores is a probability score that the corresponding second parameter candidate is a call category for the call.

19. A non-transitory computer-readable storage medium comprising computer executable instructions, which when executed by a processor, perform the method of claim 5, the method further comprising:
receiving, at then annotator device, from the call analytics server (CAS), a transcript, the at least one first parameter and the at least one second parameter associated with the transcript;
displaying, at the annotator device, the transcript, and at least one of the at least one first parameter, or the at least one second parameter;
receiving, at the annotator device, a human input on at least one of the transcript, the at least one first parameter, or the at least one second parameter; and
sending, from the annotator device, the human input to the call analytics server (CAS).

20. A non-transitory computer-readable storage medium of claim 19, wherein the annotator device is remote to the CAS.
